(19) United States
(12) Patent Application Publication
(10) Pub. No.: US 2019/0228492 A1
(43) Pub. Date: Jul. 25, 2019

(54) SHARED RIDE RESERVATION SYSTEM

(71) Applicant: TOYOTA JIDOSHA KABUSHIKI KAISHA, Toyota-shi (JP)

(72) Inventors: Atsushi MIZUTANI, Toyota-shi (JP); Yuma SAIKI, Toyota-shi (JP); Momoko AZUMA, Itabashi-ku (JP); Yusaku MORITA, Miyoshi-shi (JP); Kanako NARUSE, Toyota-shi (JP)

(73) Assignee: TOYOTA JIDOSHA KABUSHIKI KAISHA, Toyota-shi (JP)

(21) Appl. No.: 16/245,277

(22) Filed: Jan. 11, 2019

(30) Foreign Application Priority Data
Jan. 25, 2018 (JP) 2018-010551

(51) Int. Cl. G06Q 50/30; G06K 9/00; G06T 7/60; G06Q 10/02

(52) U.S. Cl. CPC G06Q 50/30; G06Q 10/02; G06T 7/60; G06K 9/00664

(57) ABSTRACT

The present disclosure provides, a shared ride reservation system that includes a detection unit that detects baggage identification data used for identifying baggage that a user who rides a vehicle intends to carry; a baggage information identification unit that identifies at least size information of the baggage, based on the baggage identification data: a matching unit that determines whether or not the baggage can be carried on the vehicle, based on the size information of the baggage, the matching unit successfully or unsuccessfully making a reservation for the user on a shared ride on the vehicle based on a result of the determination; and an output unit that outputs information that the user can or cannot share a ride.

### CROSS-REFERENCE TO RELATED APPLICATION

This application claims priority under 35 USC 119 from Japanese Patent application No. 2018-010551 tiled on Jan. 25, 2018, the disclosure of which is incorporated by reference herein in its entirety.

### BACKGROUND

### Technical Field

The present disclosure relates to a shared ride reservation system.

### Related Art

Japanese Patent Application Laid-Open No. 2016-194854 discloses an invention relating to a shared ride support system. In the shared ride support system, in a case where a driver who drives his or her own vehicle registers an itinerary, and a passenger who desires to share a ride on the registered itinerary makes a reservation, matching is achieved and each of the driver and the passenger is informed of the achievement of matching. Therefore, a shared ride can be easily achieved.

However, in the shared ride support system disclosed in Japanese Patent Application Laid-Open No. 2016-194854, it is difficult for the passenger to know the size of baggage space for carrying baggage, in the vehicle that the passenger intends to ride. Depending on the size of the driver's baggage and the size of the passenger's baggage, the passenger's baggage may not be able to be carried on the vehicle to be ridden, and therefore convenience of the shared ride may be impaired. The prior art is susceptible to improvement in this regard.

### SUMMARY

Considering the circumstance described above, the present disclosure provides a shared ride reservation system that can improve convenience in shared rides.

### Means for Solving the Problem

A first aspect of the present disclosure is a shared ride reservation system that includes a detection unit that detects baggage identification data used for identifying baggage that a user who rides a vehicle intends to carry; a baggage information identification unit that identifies at least size information of the baggage, based on the baggage identification data; a matching unit that determines whether or not the baggage can be carried on the vehicle, based on the size information of the baggage, the matching unit successfully or unsuccessfully making a reservation for the user on a shared ride on the vehicle based on a result of the determination; and an output unit that outputs information that the user can or cannot share a ride.

According to the first aspect, the shared ride reservation system includes the detection unit, the baggage information identification unit, the matching unit, and the output unit. In a case where the user desires to share a ride on the vehicle, the detection unit detects the baggage identification data used for identifying the baggage that the user intends to carry. The baggage information identification unit identifies at least the size information of the baggage, based on the detected baggage identification data. After that, the matching unit that determines whether or not the baggage can be carried on the vehicle on which the user desires to share a ride, based on the size information of the baggage. The matching unit successfully or unsuccessfully makes the reservation for the user on the shared ride on the vehicle based on a result of the determination. In a case where the baggage cannot be carried, the reservation fails. Therefore, it is possible to prevent a situation in which, even if the user shares a ride on the vehicle, the user cannot carry his or her baggage on the vehicle.

The “user” includes a driver who drives a vehicle, a passenger who shares a ride on a vehicle driven by a driver or an automatic driving vehicle, and an applicant who desires to share a ride thereon.

The “baggage identification data” includes image data that images baggage, sound data and text data that indicate the name, size, or the like of the baggage, a category data that categorizes baggage in accordance with its type, size, and the like.

According to a second aspect of the present disclosure, in the first aspect, the baggage information identification unit stores information about the baggage for which the size information is identified and information about the user who intends to carry the baggage, in association with each other, and in a case in which the user causes the detection unit to detect the baggage identification data, the baggage about which the information is stored in the baggage information identification unit in association with the user, is selectable.

According to the second aspect, the baggage information identification unit stores the information about the baggage the size information of which is identified, and the information about the user who intends to carry the baggage, in association with each other. In a case where the user makes the detection unit detect baggage identification data of baggage to be carried next time, the baggage the information of which is stored in the baggage information identification unit in association with the user is selectable. Therefore, in a case where the user desires to share a ride again with the same baggage as in the previous shared ride, the baggage identification data of the baggage can be easily detected.

According to a third aspect of the present disclosure, in the first or second aspect, the detection unit is a user terminal possessed by the user. The baggage identification data is image data of the baggage captured by the user terminal.

According to the third aspect, the detection unit is the user terminal possessed by the user. The baggage identification data is the image data of the baggage captured by the user terminal. Therefore, the user can easily input the baggage identification data of the baggage on site, without measuring the size and the like of the baggage to be carried.

According to a fourth aspect of the present disclosure, in any one of the first to third aspects, in a case in which the matching unit has determined, based on the size information of the baggage, that the baggage cannot be carried on the vehicle, the matching unit notifies the user of carriable baggage size information.

According to the fourth aspect, in a case where the matching unit has determined that the baggage to be carried cannot be carried on the vehicle, the matching unit notifies the user of the carriable baggage size information. Therefore, the user can consider whether to organize the baggage or to ride a different vehicle, based on the carriable baggage size information. In other words, the user is provided with increased options.

According to a fifth aspect of the present disclosure, in any one of the first to fourth aspects, the baggage information identification unit identifies at least the size information of the baggage, based on the baggage identification data, from a baggage database storing a plurality of types of baggage information or information accessible through a communication network.

According to the fifth aspect, the baggage information identification unit identifies at least the size information of the baggage, based on the detected baggage identification data, from the baggage database storing the plurality of types of baggage information or the information accessible through the communication network. Therefore, it is possible to easily obtain the size information and the like with high accuracy.

According to a sixth aspect of the present disclosure, in any one of the first to fourth aspects, the baggage information identification unit identifies at least the size information of the baggage, based on the baggage identification data, from a baggage database storing a plurality of types of baggage information.

According to the sixth aspect, the baggage information identification unit identifies at least the size information of the baggage, based on the detected baggage identification data, from the baggage database storing the plurality of types of baggage information. Therefore, it is possible to obtain the size information and the like, irrespective of conditions of the communication network.

According to a seventh aspect of the present disclosure, in any one of the first to sixth aspects, the detection unit is an imaging device. The baggage identification data is image data of the baggage captured by the imaging device. The baggage information identification unit estimates the size information of the baggage from an image processing result of the image data.

According to the seventh aspect, the detection unit is the imaging device. The baggage identification data is the image data of the baggage captured by the imaging device. Therefore, the user can easily input the baggage identification data of the baggage, without measuring the size of the baggage to be carried.

According to an eighth aspect of the present disclosure, in any one of the first to seventh aspects, the baggage information identification unit identifies at least one of property information, a shape, or a weight of the baggage, based on the baggage identification data, and the matching unit determines whether or not the baggage can be carried on the vehicle, based on at least one of the property information, the shape, or the weight of the baggage identified by the baggage information identification unit.

According to the eighth aspect, the baggage information identification unit identifies at least one of the property information, the shape, or the weight of the baggage, based on the detected baggage identification data. After that, the matching unit determines whether or not the baggage can be carried on the vehicle that the user desires to share a ride, based on at least one of the property information, the shape, or the weight of the baggage identified by the baggage information identification unit. In other words, the matching unit can determine whether or not the baggage can be carried with high accuracy, based on more detailed information of the baggage identified by the baggage information identification unit. Therefore, it is possible to successfully or unsuccessfully make the reservation for the user on the shared ride, based on a more accurate result of determining whether or not the baggage can be carried, thus allowing achieving an unwasted and efficient shared ride.

According to a ninth aspect of the present disclosure, in any one of the first to eighth aspects, the baggage identification data includes sound data.

According to the ninth aspect, the baggage identification data is the sound data. Therefore, the user can easily input the baggage identification data of the baggage on site, by talking the baggage identification data of the baggage to be carried, without measuring the size and the like of the baggage.

According to a tenth aspect of the present disclosure, in any one of the first to ninth aspects, the baggage identification data includes text data.

According to the tenth aspect, the baggage identification data is the text data. Therefore, since the user can input the baggage identification data of the baggage to be carried in detail as the text data, the baggage information identification unit can identify at least the size information of the baggage with high accuracy.

As described above, the shared ride reservation system according to the first aspect can improve convenience in shared rides.

The shared ride reservation systems according to the second to tenth aspects can further improve convenience in shared rides.

### BRIEF DESCRIPTION OF THE DRAWINGS

Exemplary embodiments of the present disclosure will be described in detail based in the following figures, wherein:

FIG. 1 is a schematic diagram showing the summary of a shared ride reservation system according to a first embodiment;

FIG. 2 is a flowchart schematically showing a driver's itinerary registration process in the shared ride reservation system according to the first embodiment;

FIGS. 3A and 3B are a flowchart schematically showing a passenger reservation process in the shared ride reservation system according to the first embodiment;

FIG. 4 is a schematic diagram showing an example of an input of baggage identification data to the shared ride reservation system according to the first embodiment;

FIG. 5 is a schematic diagram showing an example of display on a screen of a user terminal in inputting the baggage identification data to the shared ride reservation system according to the first embodiment;

FIG. 6 is a flowchart schematically showing a process in a case where the baggage identification data is category information, in the shared ride reservation system according to the first embodiment; and

FIG. 7 is a flowchart schematically showing a passenger reservation process in a shared ride reservation system according to a second embodiment.

### DETAILED DESCRIPTION

### First Embodiment

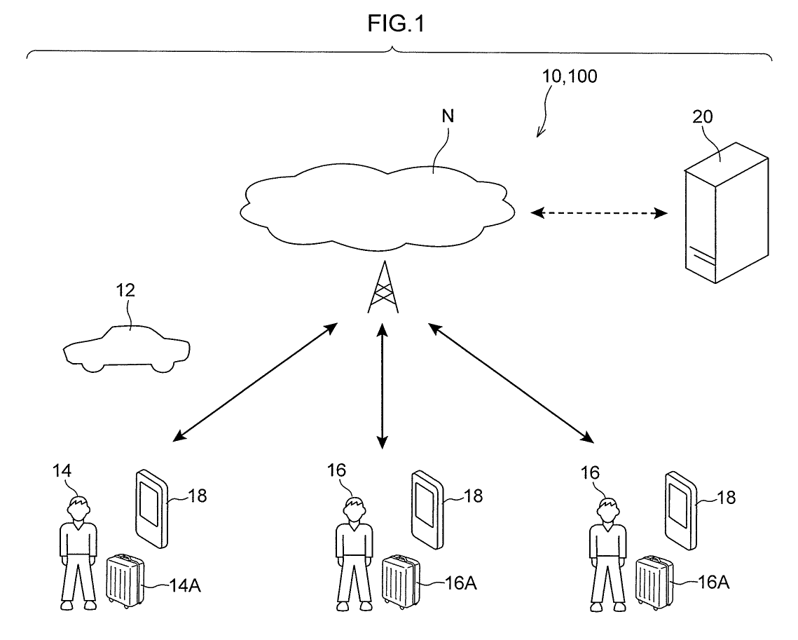

An embodiment of a shared ride reservation system according to the present disclosure will be described below with reference to FIGS. 1 to 6.

### Entire Configuration

As shown in FIG. 1, a shared ride reservation system 10 according to this embodiment has user terminals 18, functioning as detection units and output units, that are possessed by individual users including a driver 14 who drives a vehicle 12 and passengers 16 who desire to share a ride on the vehicle 12, and a management server 20 that functions as a baggage information identification unit and a matching unit. The user terminal 18 possessed by each passenger 16 is a terminal that is accessible to the management server 20 through a communication network N, such as mobile communication service, e.g. 3G, LTE, or the like, as communications network lines, or the Internet. Note that, in this embodiment, the communication network N is the mobile communication service or the Internet, but not limited thereto, the communication network N may be a closed network that is separate from a public network.

The user terminal 18. e.g. a smartphone, a mobile phone, a tablet terminal, a personal computer, or the like, has a CPU, a ROM, a RAM, storage, a communication interface, a display device, an input device, an imaging device, a sound input device, and the like (none of them is illustrated). The CPU is a processor that executes programs stored in the storage, to perform various computations. The ROM is a nonvolatile memory device that stores a program and data used for actuating the user terminal 18. The RAM is a volatile memory device that functions as a work area, while the CPU executes the programs. The storage is a nonvolatile memory device that stores various types of programs, such as an OS and an application program, and data. The communication interface is an interface that establishes communications with other devices. In this embodiment, the communication interface has the function of establishing wireless communications in conformity with various communications standards.

The display device, which is a device for displaying information, includes, for example, a liquid crystal display or an organic EL display. The input device, which is a device from which the passenger 16 inputs a command or information to the user terminal 18, includes at least one of, for example, a touch sensor, a key pad, or a button. In this embodiment, the user terminal 18 has a touch screen. With the user's touch of an UI image (button, icon, or the like) displayed on the display device, a command is inputted to the user terminal 18. The imaging device has a visible camera that captures at least static images. The sound input device has a microphone, and records sound.

The storage stores a program thereinafter referred to as “a client application”) to make the computer device function as a client of the shared ride reservation system 10. By using the client application in conjunction with the other software and hardware elements such as the OS, the detection unit is installed in the user terminal 18.

The management server 20 is, for example, a general-purpose computer device having a CPU, a ROM, a RAM, storage, and a communication interface (none of them is illustrated). The CPU is a processor that executes programs stored in the storage, to perform various computations. The ROM is a nonvolatile memory device that stores a program and data used for actuating the server. The RAM is a volatile memory device that functions as a work area, while the CPU executes the programs. The storage is a nonvolatile memory device that stores various types of programs, such as an OS and an application program, and data. The communication interface is an interface that establishes communications with other devices, such as the user terminals 18, and the communication network N.

The storage stores a server program to make the computer device function as a server of the shared ride reservation system 10. By executing the server program by the CPU, the baggage information identification unit, the matching unit, and the information output unit are installed in the management server 20. Furthermore, the storage stores databases in which data used in the shared ride reservation system 10 is stored. The databases used in the shared ride reservation system 10 include a user database, a reservation database, and a baggage database.

### Operation

The operation of the shared ride reservation system 10 will be described. The shared ride reservation system 10 is operated by a provider of the shared ride reservation system 10. The driver 14 and the passengers 16 who intend to use the shared ride reservation system 10 each perform user registration in advance. In the user registration, profile information (unique information) of the driver 14 or each passenger 16 himself or herself is inputted. The profile information includes, for example, a user name, a password, a sex, an age, an address, an E-mail address, and a face photo. Note that, in the shared ride reservation system 10, there is no distinction between the driver 14 and the passengers 16 at the time of the user registration, but for the sake of convenience of explanation, “driver” and “passengers” are differentiated here. The profile information of the user to be the driver 14 further includes information about his or her own car, including, for example, a car model, a model year of the car, a color, an exterior picture, a baggage carrying capacity, and the like. The profile information is stored in the user database of the management server 20. Note that, the baggage carrying capacity of the vehicle 12 stored in the user database is information obtained from a maker of the vehicle 12, information that the driver 14 or the like has actually measured, or the like, in the concrete.

### Registration by Driver

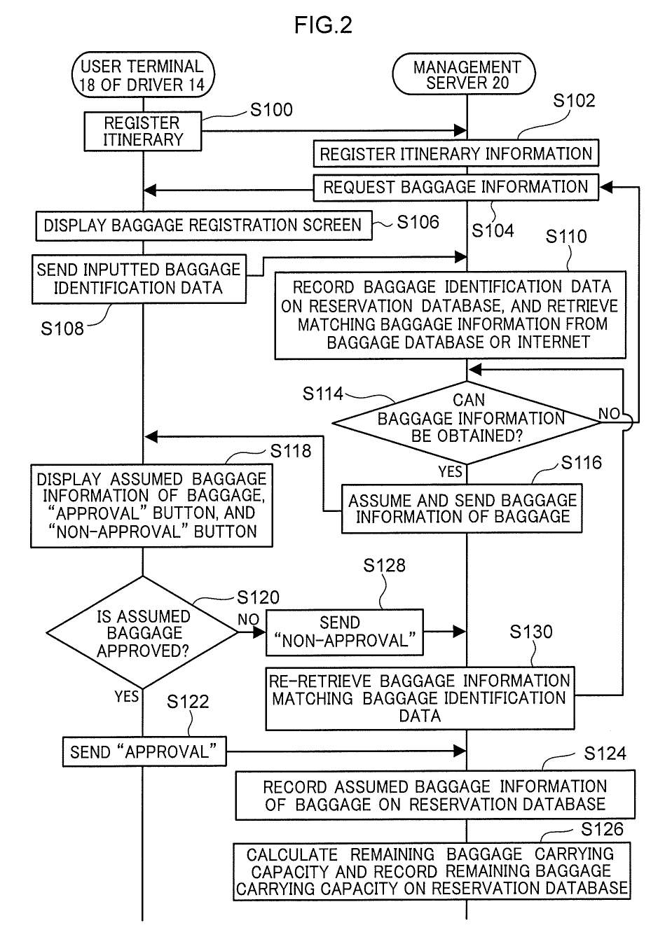

FIG. 2 is a flowchart showing a detailed example of a process in which the driver 14 registers an itinerary in the shared ride reservation system 10. In the shared ride reservation system according to this embodiment, a user to be the driver 14 invites users (passengers 16) who desire to share a ride on the itinerary, and the passengers 16 apply for a shared ride.

In step S100, the driver 14 inputs an itinerary that invites users who desire to share a ride to the user terminal 18, in order to register the itinerary in the management server 20. In this registration, a departure date and time, a departure place, a destination, and the number of persons who can share a ride are registered in the management server 20 through the user terminal 18. In step S102, the CPU of the management server 20 records the data received from the user terminal 18 of the driver 14 on the reservation database. Next, in step S104, the management server 20 requests the user terminal 18 of the driver 14 to input baggage identification data on baggage 14A that the driver 14 intends to carry.

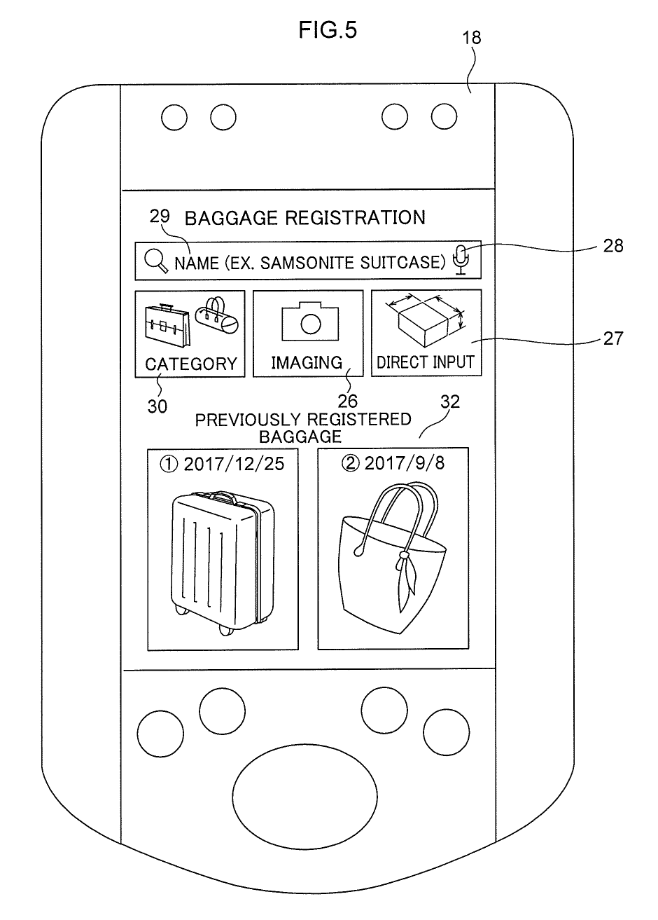

Upon receiving the notification about the input of the baggage identification data on the baggage from the management server 20, in step S106, the CPU of the user terminal 18 of the driver 14 displays a baggage registration screen, as shown in FIG. 5, on the display device. The driver 14 selects an arbitrary baggage identification data item from a plurality of baggage identification data items, and inputs the selected item in the baggage registration screen.

### Baggage Identification Data in Image Data Format

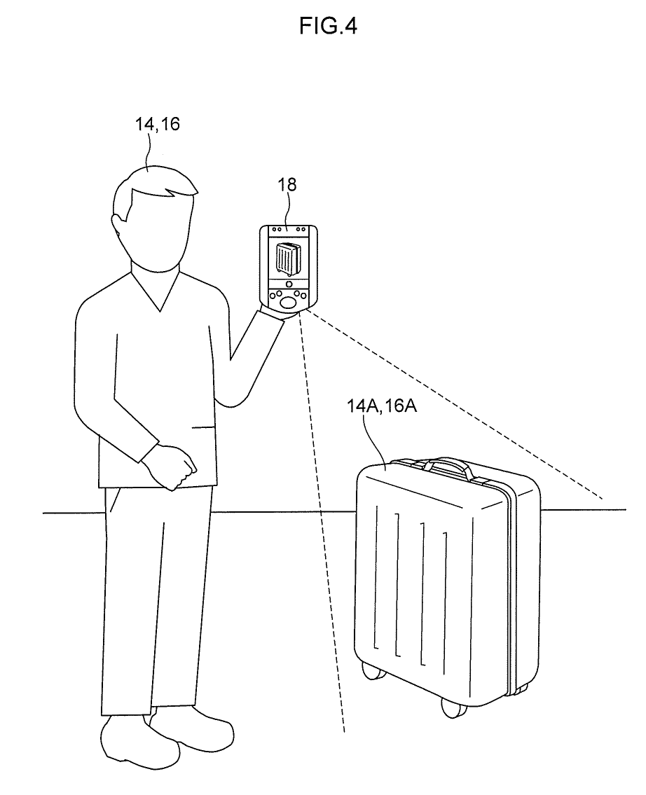

The baggage identification data of the baggage is at least one of image data, sound data, text data, category data that is categorized in advance on a baggage type basis, or the like. The baggage identification data is detected by the user terminal 18. In a case where image data is used as the baggage identification data, as an example, the driver 14 actuates the imaging device of the user terminal 18, by pressing an “imaging” button 26 displayed on the baggage registration screen of the user terminal 18 in inputting the baggage identification data. As shown in FIG. 4, the driver 14 takes an image of the baggage 14A to be carried, with the user terminal 18. Then, as shown in step S108 of FIG. 2, the driver 14 sends the taken image from the user terminal 18 to the management server 20 (refer to FIG. 1).

In step S110, the CPU of the management server 20 records the image data received from the user terminal 18 on the reservation database, and performs matching between the baggage 14A of the image data and baggage information recorded on the baggage database. Note that, the baggage information includes at least size information (for example, a vertical dimension, a horizontal dimension, and a height dimension) of the baggage, out of the size information, capacity, exterior shape, weight, property information such as “breakable” or “do not turn over” of the baggage.

The baggage database stores baggage information of various types of baggage, in advance. The CPU of the management server 20 retrieves baggage that matches the exterior shape of the baggage 14A of the image data sent from the user terminal 18, in the baggage database. If baggage that matches the image data sent from the user terminal 18 is not found, accessible information is retrieved through the communication network N. If baggage that matches the image data is found, the baggage information of the baggage is retrieved in step S114. In step S116, the baggage information is assumed to be baggage information of the baggage 14A of the image data, and an assumption result is sent to the user terminal 18 of the driver 14.

On the other hand, if baggage that matches the image data is not found in step S114, the operation returns to step S104. The management server 20 requests the user terminal 18 of the driver 14 to re-input baggage identification data of the baggage 14A that the driver 14 intends to carry. Although not illustrated, in the case of requesting the re-input of the baggage identification data of the baggage 14A, the management server 20 may require the driver 14 to input different baggage identification data from the previous data, or to measure dimensions of the baggage 14A and input a measurement, result by pressing a “direct input” button 27 (refer to FIG. 5) on the baggage registration screen. Note that, in the case of measuring the dimensions of the baggage 14A using the “direct input” button 27, for example, after the driver 14 inputs a concrete model or the like of the user terminal 18, the driver 14 may input “how many longitudinal lengths of the user terminal 18 the vertical dimension (horizontal dimension or height dimension) of the baggage has”, instead that the driver 14 measures the dimensions using a general measure or the like. The management server 20 calculates actual dimensions from an input result, and assumes that a calculation result is baggage information of the baggage 14A.

### Baggage Identification Data in Sound Data Format

In a case where sound data is used as the baggage identification data of the baggage, the driver 14 actuates the sound input device of the user terminal 18, by pressing a “talk” button 28 (refer to FIG. 5) displayed on the baggage registration screen of the user terminal 18 in inputting the baggage identification data. The driver 14 talks the type or name of the baggage that, the driver 14 intends to carry (for example, “Samsonite (trademark) suitcase” or the like). When the talk is finished, in step S108, the CPU of the user terminal 18 sends sound data obtained by the talk to the management server 20. The CPU of the management server 20 analyzes the sound data received from the user terminal 18, and generates text information based on the sound data. In step S110, the CPU of the management server 20 records the text information, together with the sound data, on the reservation database. The CPU of the management server 20 performs matching between the generated text information and the baggage database (or information accessible through the communication network N). In step S114, if baggage that matches the text information is found, baggage information of the baggage is obtained. In step S116, the baggage information is assumed to be baggage information of the baggage 14A indicated by the sound data, and an assumption result is sent to the user terminal 18 of the driver 14.

On the other hand, if baggage that matches the text information is not found in step S114, as in the case of the above-described image data, the operation returns to step S104. The management server 20 requests the user terminal 18 of the driver 14 to re-input baggage identification data of the baggage 14A that the driver 14 intends to carry.

### Baggage Identification Data in Text Data Format

In a case where text data is used as the baggage identification data of the baggage, the driver 14 inputs the type or name of the baggage that, the driver 14 intends to carry (for example, “Samsonite (trademark) suitcase” or the like) as text data, into a “search box” 29 (refer to FIG. 5) that is displayed on the baggage registration screen of the user terminal 18 in inputting the baggage identification data. After that, upon pressing a not-illustrated “search” button, the CPU of the user terminal 18 sends the inputted text data to the management server 20. In step S110, the CPU of the management server 20 records the text data received from the user terminal 18 on the reservation database. The CPU of the management server 20 performs matching between the text data and the baggage database (or information accessible through the communication network N). In step S114, if baggage that matches the text data is found, baggage information of the baggage is obtained. In step S116, the baggage information is assumed to be baggage information of the baggage 14A indicated by the text data, and an assumption result is sent to the user terminal 18 of the driver 14.

On the other hand, if baggage that matches the text data is not found in step S114, as in the case of the above-described image data, the operation returns to step S104. The management server 20 requests the user terminal 18 of the driver 14 to re-input baggage identification data of the baggage 14A that the driver 14 intends to carry.

### Baggage Identification Data in Category Data Format

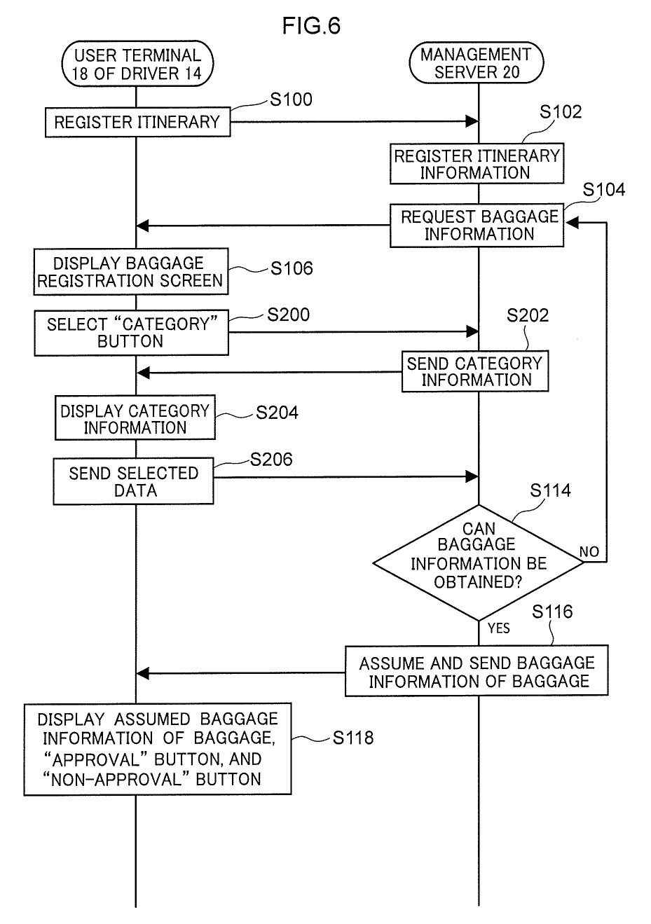

In a case where category data is used as the baggage identification data of the baggage, the driver 14 presses a “category” button 30 (refer to FIG. 5) that is displayed on the baggage registration screen of the user terminal 18 in inputting the baggage identification data. Upon pressing the “category” button 30, as shown in FIG. 6, the CPU of the user terminal 18 notifies the management server 20, in step S200, that the “category” button 30 has been pressed. Upon receiving the notification that the “category” button 30 has been pressed, in step S202, the CPU of the management server 20 sends category information in which baggage is categorized based on its type, size, or the like, e.g. into a suitcase, a Boston bag, and the like, back to the user terminal 18. In step S204, the CPU of the user terminal 18 displays the category information received from the management server 20 on the display device, and let the driver 14 select category information corresponding to the baggage 14A that the driver 14 intends to carry. In step S206, the user terminal 18 sends the selected data to the management server 20. In step S110, the CPU of the management server 20 records the category information received from the user terminal 18 on the reservation database. The CPU of the management server 20 performs matching between the category information and the baggage database (or information accessible through the communication network N). In step S114, if baggage that matches the category information is found, baggage information of the baggage is obtained. In step S116, the baggage information is assumed to be baggage information of the baggage 14A indicated by the category information, and an assumption result is sent to the user terminal 18 of the driver 14.

On the other hand, if baggage that matches the category information is not found in step S114, as in the case of the above-described image data, the operation returns to step S104. The management server 20 requests the user terminal 18 of the driver 14 to re-input baggage identification data of the baggage 14A that the driver 14 intends to carry.

### Baggage Information Registration

As shown in FIG. 2, in step S118, the CPU of the user terminal 18 of the driver 14 displays the assumption result of the baggage 14A received from the management server 20, an “approval” button, and a “non-approval” button on the display device (none of them is illustrated). If the assumption result of the baggage 14A is almost right, the driver 14 presses the “approval” button. If the “approval” button is pressed in step S120, the CPU of the user terminal 18 of the driver 14 sends a notification about the approval to the management server 20 in step S122. In step S124, the CPU of the management server 20 records the baggage information including at least the size information, on the reservation database and the user database. In step S126, the CPU of the management server 20 calculates remaining baggage can gyring capacity by subtracting the size, capacity, or the like of the baggage 14A from the baggage carrying capacity of the vehicle 12 recorded on the user database, and records the remaining baggage carrying capacity on the reservation database. Note that, in a case where the driver 14 inputs baggage identification data next time or later, the baggage information of the baggage 14A of the driver 14 recorded on the user database is displayed on “previously registered baggage” boxes 32 of the baggage registration screen, and is selectable therefrom. At this time, a ride date, a ride section, and the like may be displayed, together with the inputted image data.

On the other hand, if the assumption result of the baggage 14A displayed in step S118 is not right, the driver 14 presses the “non-approval” button in step S120. Upon pressing the “non-approval” button, in step S128. the CPU of the user terminal 18 of the driver 14 sends notification about the non-approval to the management server 20. In step S130, the CPU of the management server 20 re-retrieves baggage that matches the baggage identification data of the baggage 14A, in the baggage database or information accessible through the communication network N. In step S114, if baggage that matches the baggage identification data is found, baggage information of the baggage is obtained. In step S116, the baggage information is assumed to be baggage information of the baggage 14A, and an assumption result is sent to the user terminal 18 of the driver 14 as a second candidate. On the other hand, if baggage that matches the baggage identification data is not found in step S114, the operation returns to step S104. The management server 20 requests the user terminal 18 of the driver 14 to re-input baggage identification data of the baggage 14A that the driver 14 intends to carry. The above steps are repeated, until, a notification about a press of the “approval” button is received. Note that, although not illustrated, in a case where the “non-approval” button is pressed, the management server 20 may request the user terminal 18 of the driver 14 to input different baggage identification data (for example, a result of directly measuring a baggage size by the driver),

### Registration by Passenger

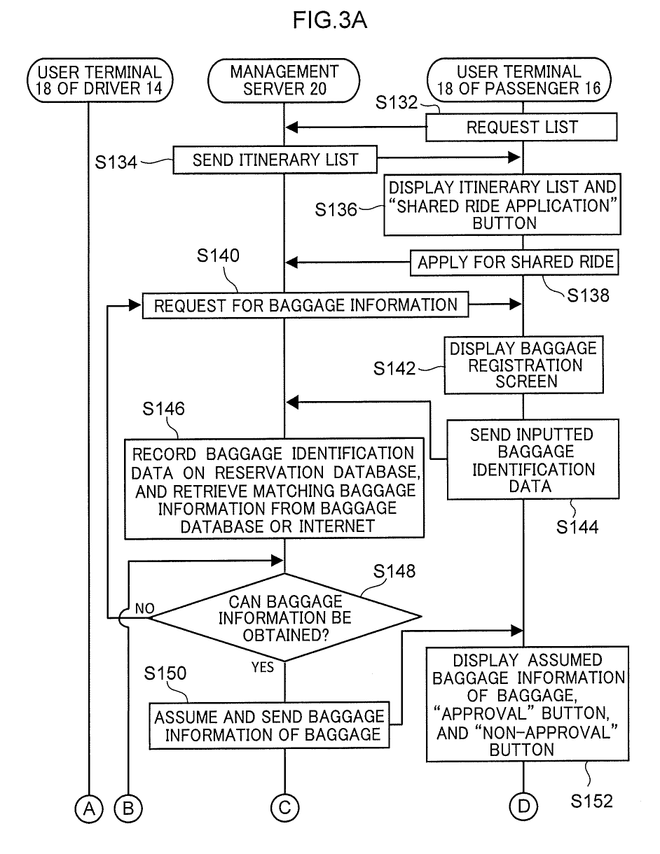

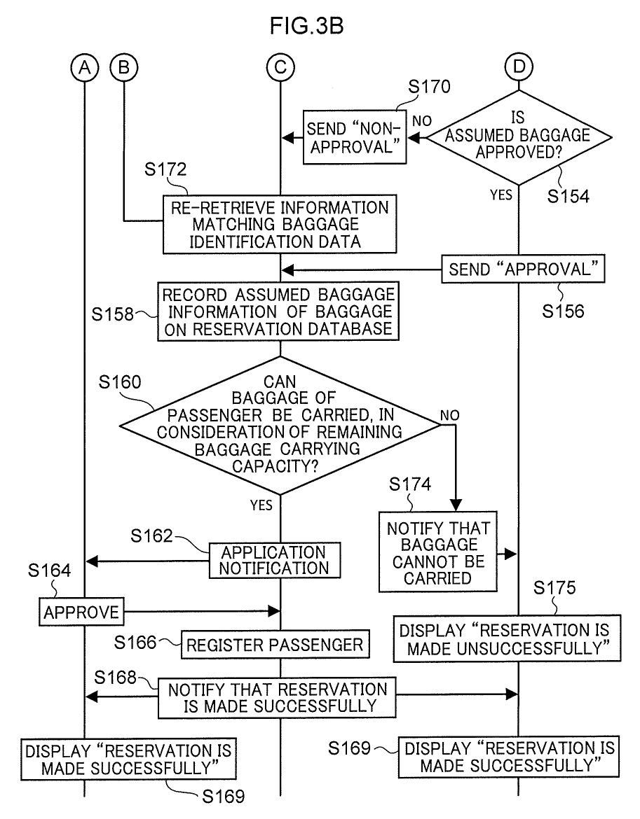

As shown in FIG. 3A, in step S132, the CPU of the user terminal 18 of the passenger 16 sends an itinerary list transmission request to the management server 20, in response to a command from the passenger 16. This transmission request includes a refinement criterion to refine a search for itineraries from a plurality of itineraries registered in the reservation database.

In step S134, the CPU of the management server 20 extracts itineraries that match the refinement criterion included in the transmission request received from the user terminal 18 of the passenger 16, from the reservation database. The CPU of the management server 20 sends data about a list of the extracted itineraries to the user terminal 18 of the passenger 16 who has sent the transmission request.

In step S136, the CPU of the user terminal 18 of the passenger 16 displays the itinerary list data received from the management server 20 and a “shared ride application” button on the display device (none of them is illustrated). If the passenger 16 desires to make a reservation for a shared ride on one of the displayed itineraries, the passenger 16 presses the “shared ride application” button. Upon pressing the “shared ride application” button, in step S138, the CPU of the user terminal 18 of the passenger 16 sends a notification about the application to the management server 20. In step S140, the management server 20 requests the user terminal 18 of the passenger 16 to input baggage identification data on baggage 16A (refer to FIG. 4) that the passenger 16 intends to carry.

Upon receiving the notification about the input of the baggage identification data on the baggage 16A from the management server 20, in step S142, the CPU of the user terminal 18 of the passenger 16 displays a baggage registration screen, as shown in FIG. 5, on the display device. As in the case of the driver 14, as described above, the passenger 16 inputs a baggage identification data item, out of various types of baggage identification data items. In this embodiment, as shown in FIG. 4, the passenger 16 takes an image of the baggage 16A to be carried, with the user terminal 18, and as shown in step S144 of FIG. 3A, sends the taken image from the user terminal 18 to the management server 20. In this embodiment, the passenger 16 inputs the image data as the baggage identification data, but not limited thereto, sound data, text data, category information, directly measured dimensions, or the like may be inputted as the baggage identification data, as described above, as a matter of course.

In step S146, the CPU of the management server 20 records the image data received from the user terminal 18 on the reservation database, and performs matching between the image data and the baggage database (or information accessible through the communication network N). In step S148, if baggage that matches the image data is found, baggage information of the baggage is obtained. In step S150, the baggage information is assumed to be baggage information of the baggage 16A indicated by the image data, and an assumption result is sent to the user terminal 18 of the passenger 16.

In step S152, the CPU of the user terminal 18 of the passenger 16 displays the assumption result of the baggage 16A of the passenger 16 received from the management server 20, an “approval” button and a “non-approval” button on the display device (none of them is illustrated). If the assumption result of the baggage 16A is almost right, the passenger 16 presses the “approval” button. If the “approval” button is pressed, in step S156. the CPU of the user terminal 18 of the passenger 16 sends a notification about the approval to the management server 20. In step S158, the CPU of the management server 20 records the baggage information, including the size information and the like of the baggage 16A, on the reservation database. The baggage information is thereby accumulated in the baggage database. In step S160, the CPU of the management server 20 determines whether or not the baggage 16A can be carried based on the remaining baggage carrying capacity registered in the reservation database. If the baggage 16A of the passenger 16 can be carried, in step S162, the CPU of the management server 20 sends an application notification, information about the passenger 16, information about the baggage 16A that the passenger 16 intends to carry, and the like to the user terminal 18 of the driver 14. On the other hand, if the baggage 16A of the passenger 16 cannot be carried, in step S174, the CPU of the management server 20 notifies the user terminal 18 of the passenger 16 that the baggage 16A cannot be carried, and the CPU of the management server 20 displays on the display device that the reservation is made unsuccessfully (step S175).

Upon receiving the application notification from the management server 20, the CPU of the user terminal 18 of the driver 14 displays the information about the passenger 16, the information about the baggage 16A that the passenger 16 intends to carry, an “approval” button, and a “non-approval” button on the display device (none of them is illustrated). If the driver 14 presses the “approval” button, in step S164, the CPU of the user terminal 18 of the driver 14 sends a notification about the, approval to the management server 20.

Upon receiving the notification about the approval from the user terminal 18 of the driver 14, in step S166, the CPU of the management server 20 registers the passenger 16 and the baggage 16A of the passenger 16 in the corresponding itinerary, as passenger registration. The CPU of the management server 20 decrements the number of remaining seats of the itinerary by one. If the number of remaining seats of the itinerary becomes zero, the CPU of the management server 20 sets a no-vacancy flag on the itinerary. If the no-vacancy flag is set, the itinerary is excepted from the itineraries that are extracted in response to the itinerary list transmission request.

In step S168, the CPU of the management server 20 notifies the user terminal 18 of the driver 14 and the user terminal 18 of the passenger 16 that the matching (reservation) is achieved. Upon receiving the notification about the achievement in that the matching, each of the CPU of the user terminal 18 of the driver 14 and the CPU of the user terminal 18 of the passenger 16 displays on the display device that the reservation is successfully made (step S169). The reservation for a shared ride is completed, as described above.

### Operation of the First Embodiment

Next, the operation of this embodiment will be described.

In this embodiment, the management server 20 and the user terminals 18 shown in FIG. 1 include the detection unit, the baggage information identification unit, the matching unit, and the output unit. In a case where the passenger 16 shares a ride on the vehicle 12, the passenger 16 inputs the baggage identification data that is used for identifying the baggage 16A that the passenger 16 intends to carry, to the user terminal 18. The management server 20 determines at least the size information of the baggage 16A, based on the inputted baggage identification data, from the baggage database that stores information of the plurality of types of baggage or information that is accessible through the communication network N. After that, the management server 20 determines whether or not the baggage 16A can be carried on the vehicle 12 that the passenger 16 desires to share a ride, based on the size information of the baggage 16A. A baggage carriage ability is one of criteria to successfully make a reservation for a shared ride on the vehicle. On the other hand, a baggage carriage inability is one of criteria to unsuccessfully make a reservation for a shared ride on the vehicle. In other words, the passenger 16 can make a reservation for the sharable vehicle 12 that can carry the baggage 16A of the passenger 16. Therefore, it is possible to prevent a situation in which the passenger 16 cannot carry his or her baggage 16A on the vehicle 12, even if the passenger 16 shares a ride on the vehicle 12. This improves convenience in the shared ride.

The management server 20 stores information about the baggage 14A the size information of which is determined and the driver 14 who carries the baggage 14A, and information about the baggage 16A the size information of which is determined and the passenger 16 who carries the baggage 16A, in association with each other. In a case where the driver 14 or the passenger 16 inputs the baggage identification data of the baggage 14A or 16A on the detection unit next time, the baggage 14A or 16A that is associated with the driver 14 or the passenger 16, stored in the management server 20, can be selected. Therefore, in a case where the driver 14 or the passenger 16 shares a ride again with the same baggage 14A or 16A as in the previous shared ride, the baggage identification data of the baggage 14A or 16A can be easily inputted.

Furthermore, to input the baggage identification data, the user terminal 18 of the driver 14 or the passenger 16 is used. Since the baggage identification data is image data of the baggage 14A or 16A taken by the user terminal 18, the driver 14 or the passenger 16 can easily input the baggage identification data on site, without measuring the size and the like of the baggage 14A or 16A. Therefore, it is possible to further improve convenience in the shared ride.

Furthermore, the baggage carrying capacity of the baggage 16A of the passenger 16 is determined in a state that the baggage information of the baggage 14A of the driver 14 is excepted in advance from the vehicle baggage carrying capacity. In other words, since the baggage carrying capacity with higher accuracy is used as a parameter, the baggage 16A can be smoothly carried on the shared ride. Therefore, it is possible to further improve convenience in the shared ride.

### Second Embodiment

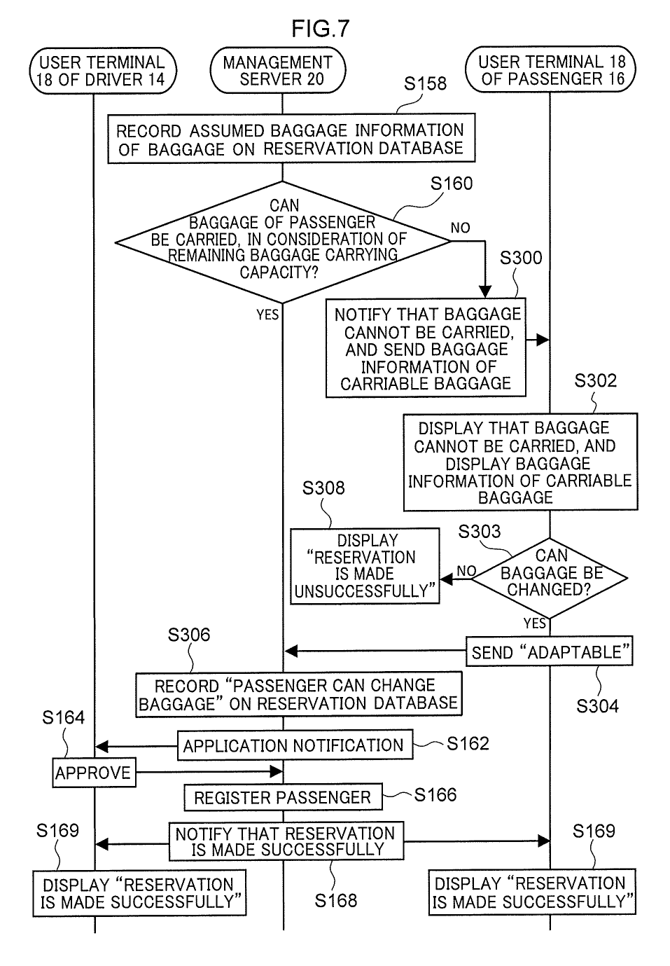

Next, a shared ride reservation system according to a second embodiment of the present disclosure will be described with reference to FIG. 7. Note that, the same components as those of the above first embodiment and the like are indicated with the same reference numerals, and description thereof is omitted.

A shared ride reservation system 100 according to the second embodiment has the same fundamental configuration as the first embodiment. The shared ride reservation system 100 has a feature that, in addition to notifying that the baggage 16A of the passenger 16 cannot be carried on the vehicle 12, the passenger 16 is notified of carriable baggage information.

As shown in FIG. 7, in step S158, the CPU of the management server 20 records the baggage information, including the size information and the like of the baggage 16A, on the reservation database. In step S160, the CPU of the management server 20 determines whether or not the baggage 16A can be carried, based on the remaining baggage carrying capacity registered in the reservation database. If the baggage 16A of the passenger 16 cannot be carried, in step S300, the CPU of the management server 20 notifies the user terminal 18 of the passenger 16 that the baggage 16A cannot be carried. At this time, the CPU of the management server 20 also notifies the user terminal 18 of the passenger 16 that what size and shape of baggage can be carried, based on the remaining baggage carrying capacity of the vehicle 12 recorded on the reservation database.

In step S302, the user terminal 18 of the passenger 16 displays information that the baggage 16A cannot be carried, and information that what size and shape of baggage can be carried, on the display device (neither is illustrated). If the passenger 16 can make the baggage 16A into the carriable size, shape, or the like by organizing or changing the baggage 16A, the passenger 16 presses an “adaptable” button (not illustrated). If the “adaptable” button is pressed in step S303, the CPU of the user terminal 18 of the passenger 16 sends a notification that the baggage 16A is adaptable, to the management server 20 in step S304.

In step S306, the CPU of the management server 20 records that the passenger 16 changes the baggage 16A into baggage that can be carried on the vehicle 12, on the reservation database. Next, in step S162, the CPU of the management server 20 sends an application notification, information about the passenger 16, information about the baggage 16A that the passenger 16 intends to carry (changing to the baggage that can be carried on the vehicle 12), and the like to the user terminal 18 of the driver 14. If the driver 14 gives approval, the CPU of the user terminal 18 of the driver 14 and the CPU of the user terminal 18 of the passenger 16 each display that a reservation is successfully made, on the individual display devices, through the same steps as in the first embodiment (step S169).

On the other hand, if the passenger 16 cannot make the baggage 16A into the carriable size, shape, or the like, the passenger 16 presses a “non-adaptable” button (not illustrated). If the “non-adaptable” button is pressed in step S303, a reservation failure is displayed on the displayed device in step S308.

### Operation and Effects of Second Embodiment

Next, the operation and effects of the second embodiment will be described.

Since the shared ride reservation system 100 is configured in the same manner as the shared ride reservation system 10 according to the first embodiment, except that the passenger 16 is notified of the carriable baggage information, in addition to notifying that the baggage 16A of the passenger 16 cannot be carried on the vehicle 12, the same effects as the first embodiment can be obtained. In a case where it is determined that the baggage 16A to be carried cannot be carried on the vehicle 12, the management server 20 notifies the passenger 16 of carriable baggage size information. Accordingly, the passenger 16 can consider whether to organize or change the baggage 16A or to ride a different vehicle, based on the carriable baggage size information. In other words, the passenger 16 is provided with increased options. Therefore, it is possible to further improve convenience in shared rides.

In the above first and second embodiments, the baggage identification data is inputted to the user terminal 18, and the user terminal 18 detects the baggage identification data. However, not limited to this, in order to detect the baggage identification data, the baggage identification data may be inputted using an imaging device installed in a building, a battery charger for electric automobiles, a vehicle, or the like, a baggage detection device having a sound input device, a text input device, or the like, or another specific terminal. At least one of the user terminal 18, the baggage detection device, or the other specific terminal may receive the baggage identification data, as a reception unit. The driver 14 or the passenger 16 may give approval to the received baggage identification data. Alternatively, a plurality of containers of different sizes are provided in advance. It may be checked that which size of the container the baggage can be contained, and the size information of the container that can contain the baggage may be detected as the baggage identification data. Furthermore, the baggage identification data may be detected in another configuration.

The detection unit is not limited, to the sensor, the user terminal 18, or the like used for inputting the image data, sound data, or text, but may be a signal reception device (for example, a signal reception device provided in the user terminal 18 or the management server 20) that receives the baggage identification data from the sensor or the user terminal 18, which is configured as an external terminal.

Furthermore, the management server 20 is configured to obtain the baggage information that is used for matching with the detected baggage identification data from the baggage database or the communication network N, but the configuration is not limited to this. For example, if a baggage information determination unit may be configured by the CPU of the user terminal 18 or the like, and the baggage database that stores a plurality of types of baggage information is stored in the user terminal 18, the baggage information can be obtained without using the communication network N.

The baggage information may be determined by directly detecting the size information or the like, instead that the baggage information that matches the detected baggage identification data is obtained from the baggage database or the communication network N. For example, the size information of the baggage may be estimated from an image processing result (using a well-known image processing technology) of the image data obtained by the imaging device of the user terminal 18.

The notification, information, or the like from the management server 20 is configured to be displayed on the display device of the user terminal 18, but not limited thereto, may be configured to be outputted to the driver 14 or the passenger 16 by sound from a speaker, or outputted from another terminal, device, or the like except the user terminal 18, such as a display device or a speaker of a car navigation system installed in the vehicle 12, a battery charger for electric automobiles, or a device installed in a building.

Furthermore, the output unit is not limited to the display device, the speaker, or the like, but may be a transmission device (for example, a signal transmission device provided in the user terminal 18 or the management server 20) that transmits an output signal to make the display device, the speaker, or the like output an image, sound, or the like.

Furthermore, the shared ride reservation systems 10 and 100 are configured to be managed in order that the passengers 16 share a ride of the vehicle 12 driven by the driver 14, but not limited thereto, the shared ride reservation systems 10 and 100 may be configured to be managed in order that the passengers 16 share a ride of an automatic driving vehicle that needs no driver. In this case, the user corresponding to the driver 14 becomes a passenger 16 too.

The user to be the driver 14 invites the passengers 16 to the itinerary, and the passenger 16 who desires to share a ride applies for it and makes a reservation. However, not limited thereto, after the passenger 16 registers a shared ride desired date, a shared ride desired section, and baggage identification data, the management server 20 may inform the passenger 16 of vehicle information that matches the registered information. If the passenger 16 gives approval to the vehicle information, a reservation may be made.

Furthermore, the management server 20 determines whether or not the baggage 14A and 16A can be carried, by making a comparison between the size information of the baggage 14A and 16A and the remaining baggage carrying capacity of the vehicle 12, but the present disclosure is not limited to this. For example, the management server 20 may determine whether or not baggage can be carried, by using the property information, shape, weight, and the like of the baggage as parameters, such as “in the case of breakable baggage, no more baggage can be placed on the baggage”.

The management server 20, which functions as the matching unit, is configured to make a reservation for a shared ride, but the present disclosure is not limited to this. Using a distributed reservation book technology provided by a block chain that is configured of a plurality of servers, terminals, and the like, the itinerary information, the baggage identification data, and the like may be stored in each of the servers, the terminals, and the like, and the user may make a reservation from data on the block chain ensuring completeness, or another configuration may be used.

The embodiments of the present disclosure are described above, but the present disclosure is not limited to the above, but, as a matter of course, can be variously modified except for the above without departing from the scope of claims.

What is claimed is:

1. A shared ride reservation system comprising:
a detection unit that detects baggage identification data used for identifying baggage that a user who rides a vehicle intends to carry;
a baggage information identification unit that identifies at least size information of the baggage, based on the baggage identification data;
a matching unit that determines whether or not the baggage can be carried on the vehicle, based on the size information of the baggage, the matching unit successfully or unsuccessfully making a reservation for the user on a shared ride on the vehicle based on a result of the determination; and
an output unit that outputs information that the user can or cannot share a ride.

2. The shared ride reservation system according to claim 1, wherein:
the baggage information identification unit stores information about the baggage for which the size information is identified and information about the user who intends to carry the baggage, in association with each other, and
in a case in which the user causes the detection unit to detect the baggage identification data, the baggage about which the information is stored in the baggage information identification unit in association with the user, is selectable.

3. The shared ride reservation system according to claim 1, wherein:
the detection unit is a user terminal possessed by the user, and
the baggage identification data is image data of the baggage captured by the user terminal.

4. The shared ride reservation system according to claims 1, wherein in a case in which the matching unit has determined, based on the size information of the baggage, that the baggage cannot be carried on the vehicle, the matching unit notifies the user of carriable baggage size information.

5. The shared ride reservation system according to claims 1, wherein the baggage information identification unit identifies at least the size information of the baggage, based on the baggage identification data, from a baggage database storing a plurality of types of baggage information or information accessible through a communication network.

6. The shared ride reservation system according to claims 1, wherein the baggage information identification unit identifies at least the size information of the baggage, based on the baggage identification data, from a baggage database storing a plurality of types of baggage information.

7. The shared ride reservation system according to claims 1, wherein:
the detection unit is an imaging device,
the baggage identification data is image data of the baggage captured by the imaging device, and
the baggage information identification unit estimates the size information of the baggage from an image processing result of the image data.

8. The shared ride reservation system according to claims 1, wherein:
the baggage information identification unit identifies at least one of property information, a shape, or a weight of the baggage, based on the baggage identification data, and
the matching unit determines whether or not the baggage can be carried on the vehicle, based on at least one of the property information, the shape, or the weight of the baggage identified by the baggage information identification unit.

9. The shared ride reservation system according to claims 1, wherein the baggage identification data includes sound data.

10. The shared ride reservation system according to claims 1, wherein the baggage identification data includes text data.
